(19) United States
(12) Patent Application Publication
(10) Pub. No.: US 2022/0207409 A1
(43) Pub. Date: Jun. 30, 2022

(54) TIMELINE RESHAPING AND RESCORING

(71) Applicant: International Business Machines Corporation, Armonk, NY (US)

(72) Inventors: Eugene Irving Kelton, Wake Forest, NC (US); Shuyan Lu, Cary, NC (US); Yi-Hui Ma, Mechanicsburg, PA (US); Brandon Harris, Union City, NJ (US)

(21) Appl. No.: 17/134,813

(22) Filed: Dec. 28, 2020

(51) Int. Cl. G06N 20/00; G06Q 30/00

(52) U.S. Cl. CPC G06N 20/00; G06Q 30/0185

(57) ABSTRACT

A system, computer program product, and method are presented for facilitating determinations of risk including behavior classifications and predictions through timeline reshaping and rescoring of structured data. One embodiment of the method includes receiving, for one or more target focal objects, at least a portion of a transaction history including a plurality of sequential transactions, where the portion of the transaction history is associated with a first temporal range. The method also includes generating a first transaction timeline image representative of the portion of the transaction history, where the first temporal range includes a first temporal scaling. The method further includes labeling, through a machine learning (ML) model, the first transaction timeline image. The method also includes reshaping the first transaction timeline image, including rescaling the first temporal range, thereby generating a rescaled transaction timeline image, and labeling the rescaled transaction timeline image.

### BACKGROUND

The present disclosure relates to behavior classifications and predictions, and, more specifically, to implementation of timeline reshaping and rescoring of structured data.

Many known mechanisms for detecting potentially fraudulent activities include general purpose systems that are configured to detect historical temporal patterns and make predictions about future patterns. The temporal processing may include learning temporal sequences, performing inference, recognizing temporal sequences, predicting temporal sequences, labeling temporal sequences, and temporal pooling. Potentially fraudulent activities may take many different forms and the detection of fraud relies on a system with the capability to recognize or discover these fraudulent activities/events. Typically, potentially fraudulent events have a temporal component, that is, such activities occur within determinable and quantifiable time periods, usually at predictable occurrences. Training machine learning systems to recognize such predictable activities facilitates leveraging traditional fraud detection logic to build fixed rules according to the particular circumstances to recognize potential fraud and flag it for further review.

### SUMMARY

A system, computer program product, and method are provided for facilitating determinations of risk including behavior classifications and predictions through timeline reshaping and rescoring of structured data.

In one aspect, a computer system is provided for administering examinations with adversarial hardening of queries against automated responses. The system includes one or more processing devices and at least one memory device operably coupled to the one or more processing devices. The one or more processing devices are configured to receive, for one or more target focal objects, at least a portion of a transaction history including a plurality of sequential transactions, where the portion of the transaction history is associated with a first temporal range. The one or more processing devices are also configured to generate a first transaction timeline image representative of the portion of the transaction history, where the first temporal range includes a first temporal scaling. The one or more processing devices are further configured to label, through a machine learning (ML) model, the first transaction timeline image. The one or more processing devices are also configured to reshape the first transaction timeline image, comprising rescaling the first temporal range, thereby generating a rescaled transaction timeline image. The one or more processing devices are further configured to label the rescaled transaction timeline image.

In another aspect, a computer program product is provided for administering examinations with adversarial hardening of queries against automated responses. The computer program product includes one or more computer readable storage media, and program instructions collectively stored on the one or more computer storage media. The product also includes program instructions to receive, for one or more target focal objects, at least a portion of a transaction history including a plurality of sequential transactions, where the portion of the transaction history is associated with a first temporal range. The computer program product also includes program instructions to generate a first transaction timeline image representative of the portion of the transaction history, where the first temporal range includes a first temporal scaling. The computer program product further includes program instructions to label, through a machine learning (ML) model, the first transaction timeline image. The computer program product also includes program instructions to reshape the first transaction timeline image, comprising rescaling the first temporal range, thereby generating a rescaled transaction timeline image. The computer program product further includes program instructions to label the rescaled transaction timeline image.

In yet another aspect, a computer-implemented method is provided for administering examinations with adversarial hardening of queries against automated responses. The method includes receiving, for one or more target focal objects, at least a portion of a transaction history including a plurality of sequential transactions, where the portion of the transaction history is associated with a first temporal range. The method also includes generating a first transaction timeline image representative of the portion of the transaction history, where the first temporal range includes a first temporal scaling. The method further includes labeling, through a machine learning (ML) model, the first transaction timeline image. The method also includes reshaping the first transaction timeline image, including rescaling the first temporal range, thereby generating a rescaled transaction timeline image, and labeling the rescaled transaction timeline image.

The present Summary is not intended to illustrate each aspect of, every implementation of, and/or every embodiment of the present disclosure. These and other features and advantages will become apparent from the following detailed description of the present embodiment(s), taken in conjunction with the accompanying drawings.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are illustrative of certain embodiments and do not limit the disclosure.

FIG. 1 is a schematic diagram illustrating a cloud computer environment, in accordance with some embodiments of the present disclosure.

FIG. 2 is a block diagram illustrating a set of functional abstraction model layers provided by the cloud computing environment, in accordance with some embodiments of the present disclosure.

FIG. 3 is a block diagram illustrating a computer system/server that may be used as a cloud-based support system, to implement the processes described herein, in accordance with some embodiments of the present disclosure.

FIG. 4 is a block diagram illustrating a computer system configured to determine risk through behavior classifications and predictions generated through timeline reshaping and rescoring of structured data, in accordance with some embodiments of the present disclosure.

FIG. 5 is a block diagram illustrating a process for determining risk through behavior classifications and predictions generated through timeline reshaping and rescoring of structured data, in accordance with some embodiments of the present disclosure.

FIG. 6 is a flowchart illustrating a process for determining risk through behavior classifications and predictions generated through timeline reshaping and rescoring of structured data, in accordance with some embodiments of the present disclosure.

FIG. 7 is a graphical diagram illustrating an original unlabeled transaction timeline image, in accordance with some embodiments of the present disclosure.

FIG. 8 is a graphical diagram illustrating a reshaped unlabeled transaction timeline image, in accordance with some embodiments of the present disclosure.

FIG. 9 is a graphical diagram illustrating a reshaped unlabeled transaction timeline image, in accordance with some embodiments of the present disclosure.

While the present disclosure is amenable to various modifications and alternative forms, specifics thereof have been shown by way of example in the drawings and will be described in detail. It should be understood, however, that the intention is not to limit the present disclosure to the particular embodiments described. On the contrary, the intention is to cover all modifications, equivalents, and alternatives falling within the spirit and scope of the present disclosure.

### DETAILED DESCRIPTION

It will be readily understood that the components of the present embodiments, as generally described and illustrated in the Figures herein, may be arranged and designed in a wide variety of different configurations. Thus, the following detailed description of the embodiments of the apparatus, system, method, and computer program product of the present embodiments, as presented in the Figures, is not intended to limit the scope of the embodiments, as claimed, but is merely representative of selected embodiments. In addition, it will be appreciated that, although specific embodiments have been described herein for purposes of illustration, various modifications may be made without departing from the spirit and scope of the embodiments.

Reference throughout this specification to “a select embodiment,” “at least one embodiment,” “one embodiment,” “another embodiment,” “other embodiments,” or “an embodiment” and similar language means that a particular feature, structure, or characteristic described in connection with the embodiment is included in at least one embodiment. Thus, appearances of the phrases “a select embodiment,” “at least one embodiment,” “in one embodiment,” “another embodiment,” “other embodiments,” or “an embodiment” in various places throughout this specification are not necessarily referring to the same embodiment.

The illustrated embodiments will be best understood by reference to the drawings, wherein like parts are designated by like numerals throughout. The following description is intended only by way of example, and simply illustrates certain selected embodiments of devices, systems, and processes that are consistent with the embodiments as claimed herein.

It is to be understood that although this disclosure includes a detailed description on cloud computing, implementation of the teachings recited herein is not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows.

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows.

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows.

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

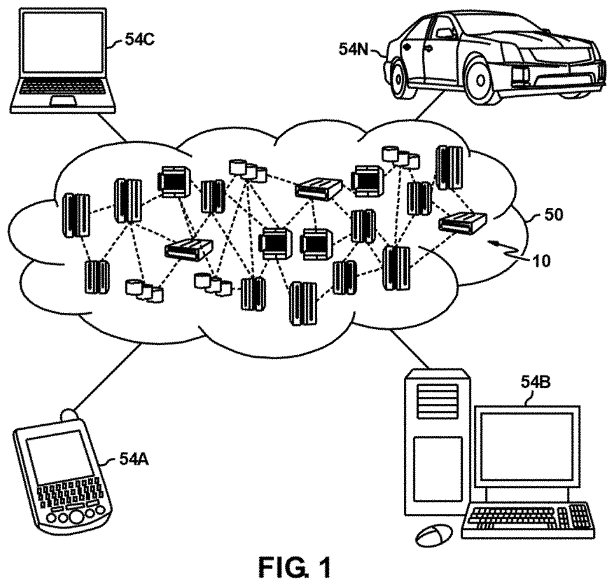

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

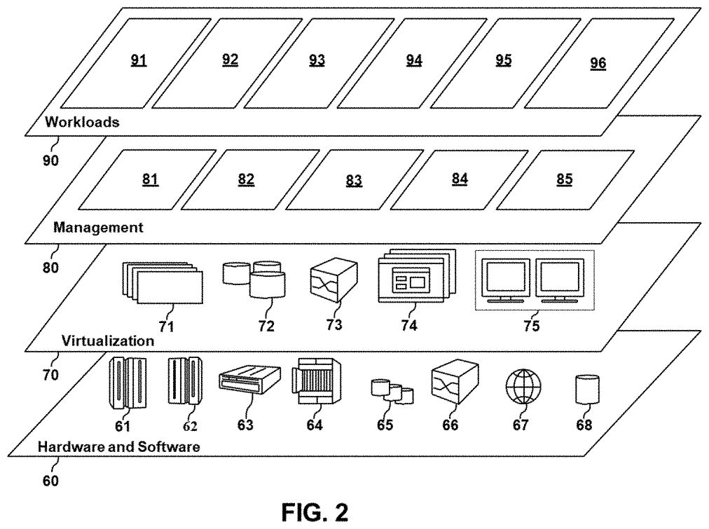

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the disclosure are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and to behavior classifications and predictions 96.

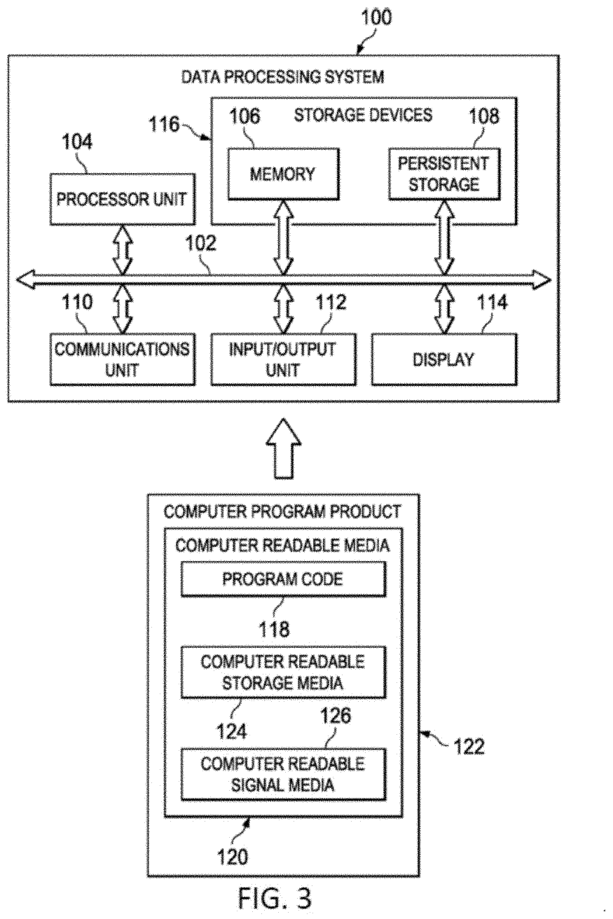

Referring to FIG. 3, a block diagram of an example data processing system, herein referred to as computer system 100, is provided. The computer system 100 may be embodied in a computer system/server in a single location, or in at least one embodiment, may be configured in a cloud-based system sharing computing resources. For example, and without limitation, the computer system 100 may be used as a cloud computing node 10.

Aspects of the computer system 100 may be embodied in a computer system/server in a single location, or in at least one embodiment, may be configured in a cloud-based system sharing computing resources as a cloud-based support system, to implement the system, tools, and processes described herein. The computer system 100 is operational with numerous other general purpose or special purpose computer system environments or configurations. Examples of well-known computer systems, environments, and/or configurations that may be suitable for use with the computer system 100 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and file systems (e.g., distributed storage environments and distributed cloud computing environments) that include any of the above systems, devices, and their equivalents.

The computer system 100 may be described in the general context of computer system-executable instructions, such as program modules, being executed by the computer system 100. Generally, program modules may include routines, programs, objects, components, logic, data structures, and so on that perform particular tasks or implement particular abstract data types. The computer system 100 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 3, the computer system 100 is shown in the form of a general-purpose computing device. The components of the computer system 100 may include, but are not limited to, one or more processors or processing devices 104 (sometimes referred to as processors and processing units), e.g., hardware processors, a system memory 106 (sometimes referred to as a memory device), and a communications bus 102 that couples various system components including the system memory 106 to the processing device 104. The communications bus 102 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. The computer system 100 typically includes a variety of computer system readable media. Such media may be any available media that is accessible by the computer system 100 and it may include both volatile and non-volatile media, removable and non-removable media. In addition, the computer system 100 may include one or more persistent storage devices 108, communications units 110, input/output (I/O) units 112, and displays 114.

The processing device 104 serves to execute instructions for software that may be loaded into the system memory 106. The processing device 104 may be a number of processors, a multi-core processor, or some other type of processor, depending on the particular implementation. A number, as used herein with reference to an item, means one or more items. Further, the processing device 104 may be implemented using a number of heterogeneous processor systems in which a main processor is present with secondary processors on a single chip. As another illustrative example, the processing device 104 may be a symmetric multiprocessor system containing multiple processors of the same type.

The system memory 106 and persistent storage 108 are examples of storage devices 116. A storage device may be any piece of hardware that is capable of storing information, such as, for example without limitation, data, program code in functional form, and/or other suitable information either on a temporary basis and/or a permanent basis. The system memory 106, in these examples, may be, for example, a random access memory or any other suitable volatile or non-volatile storage device. The system memory 106 can include computer system readable media in the form of volatile memory, such as random access memory (RAM) and/or cache memory.

The persistent storage 108 may take various forms depending on the particular implementation. For example, the persistent storage 108 may contain one or more components or devices. For example, and without limitation, the persistent storage 108 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the communication bus 102 by one or more data media interfaces.

The communications unit 110 in these examples may provide for communications with other computer systems or devices. In these examples, the communications unit 110 is a network interface card. The communications unit 110 may provide communications through the use of either or both physical and wireless communications links.

The input/output unit 112 may allow for input and output of data with other devices that may be connected to the computer system 100. For example, the input/output unit 112 may provide a connection for user input through a keyboard, a mouse, and/or some other suitable input device. Further, the input/output unit 112 may send output to a printer. The display 114 may provide a mechanism to display information to a user. Examples of the input/output units 112 that facilitate establishing communications between a variety of devices within the computer system 100 include, without limitation, network cards, modems, and input/output interface cards. In addition, the computer system 100 can communicate with one or more networks such as a local area network (LAN), a general wide area network (WAN), and/or a public network (e.g., the Internet) via a network adapter (not shown in FIG. 3). It should be understood that although not shown, other hardware and/or software components could be used in conjunction with the computer system 100. Examples of such components include, but are not limited to: microcode, device drivers, redundant processing units, external disk drive arrays, RAID systems, tape drives, and data archival storage systems.

Instructions for the operating system, applications and/or programs may be located in the storage devices 116, which are in communication with the processing device 104 through the communications bus 102. In these illustrative examples, the instructions are in a functional form on the persistent storage 108. These instructions may be loaded into the system memory 106 for execution by the processing device 104. The processes of the different embodiments may be performed by the processing device 104 using computer implemented instructions, which may be located in a memory, such as the system memory 106. These instructions are referred to as program code, computer usable program code, or computer readable program code that may be read and executed by a processor in the processing device 104. The program code in the different embodiments may be embodied on different physical or tangible computer readable media, such as the system memory 106 or the persistent storage 108, and may be physically associated with one or more other devices and access through the I/O units 112.

The program code 118 may be located in a functional form on the computer readable media 120 that is selectively removable and may be loaded onto or transferred to the computer system 100 for execution by the processing device 104. The program code 118 and computer readable media 120 may form a computer program product 122 in these examples. In one example, the computer readable media 120 may be computer readable storage media 124 or computer readable signal media 126. Computer readable storage media 124 may include, for example, an optical or magnetic disk that is inserted or placed into a drive or other device that is part of the persistent storage 108 for transfer onto a storage device, such as a hard drive, that is part of the persistent storage 108. The computer readable storage media 124 also may take the form of a persistent storage, such as a hard drive, a thumb drive, or a flash memory, that is connected to the computer system 100. In some instances, the computer readable storage media 124 may not be removable from the computer system 100.

Alternatively, the program code 118 may be transferred to the computer system 100 using the computer readable signal media 126. The computer readable signal media 126 may be, for example, a propagated data signal containing the program code 118. For example, the computer readable signal media 126 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, the program code 118 may be downloaded over a network to the persistent storage 108 from another device or computer system through the computer readable signal media 126 for use within the computer system 100. For instance, program code stored in a computer readable storage medium in a server computer system may be downloaded over a network from the server to the computer system 100. The computer system providing the program code 118 may be a server computer, a client computer, or some other device capable of storing and transmitting the program code 118.

The program code 118 may include one or more program modules (not shown in FIG. 3) that may be stored in system memory 106 by way of example, and not limitation, as well as an operating system, one or more application programs, other program modules, and program data. Each of the operating systems, one or more application programs, other program modules, and program data or some combination thereof, may include an implementation of a networking environment. The program modules of the program code 118 generally carry out the functions and/or methodologies of embodiments as described herein.

The different components illustrated for the computer system 100 are not meant to provide architectural limitations to the manner in which different embodiments may be implemented. The different illustrative embodiments may be implemented in a computer system including components in addition to or in place of those illustrated for the computer system 100.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Many known mechanisms for detecting potentially fraudulent activities include general purpose systems that are configured to detect historical temporal patterns and make predictions about future patterns. Many of these known mechanisms include researching established structured data sources, where the data to be ingested is typically highly-organized and formatted to be easily searchable in relational databases, e.g., financial reports from established financial clearinghouses. Typically, potentially fraudulent events have a temporal component, that is, such activities occur within determinable and quantifiable time periods, usually at predictable occurrences. Training known machine learning (ML) systems through supervised (or, in some cases, unsupervised) learning to recognize such predictable activities facilitates leveraging traditional fraud detection logic to build fixed rules according to the particular circumstances to recognize potential fraud and flag it for further review. The associated temporal processing may include learning temporal sequences, performing inference, recognizing temporal sequences, predicting temporal sequences, labeling temporal sequences, and temporal pooling. Potentially fraudulent activities may take many different forms and the detection of fraud relies on a system with the capability to recognize or discover these fraudulent activities/events.

Many of the aforementioned known and conventional behavior prediction techniques have become fairly sophisticated in their ability to accurately identify behavior patterns from analyzing structured data associated with target focal objects. Target focal objects may be any economic entity, e.g., and without limitation, individuals, small businesses, and large corporations. The large business entities may include, without limitation, insurance companies and banking institutions. Furthermore, target focal objects may be particular accounts associated with the entities. The aforementioned patterns may discerned through graphical displays of the ingested data. However, such known behavior prediction techniques may make it difficult to discern certain patterns of the transactions or events within the collected data due to the format of the graphical presentations of the data, including normalization features and other time scaling. For example, and without limitation, a particular entity may have knowledge of the time scales used to analyze the ingested data and may possibly be able to hide fraudulent activities through manipulating the timing of the activities, thereby escaping identification through masking the respective behaviors to deviate from known established patterns that would otherwise be evident in the established time scaling. In addition, the time scaling may be dictated by the respective financial institutions and may not necessarily be selected to identify such potentially hidden behaviors.

A system, computer program product, and method are disclosed and described herein directed toward facilitating determinations of risk including behavior classifications and predictions through timeline reshaping and rescoring of structured data. In at least some embodiments, the systems and methods described herein leverage historical data and existing transaction timeline images utilizing user interface timeline reshaping features including, without limitation, timeline compression and elongation. The appearance of the reshaped transaction timeline images are different from the historical transaction timeline images. The newly created transaction timeline images are then retested, i.e., reanalyzed through a comparison operation to determine if there are any patterns that may be similar to the known patterns representative of potentially fraudulent activities through a forced rescoring thereof. Furthermore, the reshaped transaction timeline images may be labeled to indicate newly identified fraudulent activities and are input into the respective ML models to train the ML models to identify potentially fraudulent activities on subsequent data inputs for the target focal objects. In addition, the systems and methods described herein may be used on newly ingested data to generate the varying transaction timeline images.

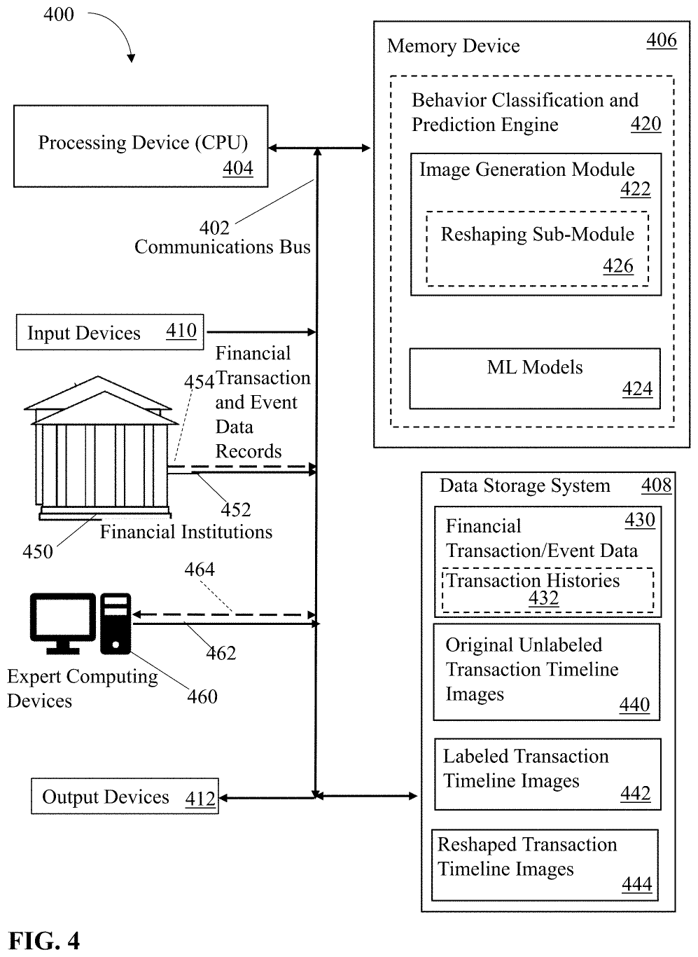

Referring to FIG. 4, a block diagram is presented illustrating a computer system, e.g., a behavior classification and prediction system 400 (hereon referred to as the system 400) configured to classify behaviors and predictions through processing temporal financial features, i.e., financial transactions and events from a financial institution (discussed further below). The system 400 is configured to determine risk, e.g., business risks, through the behavior classifications and predictions generated through timeline reshaping and rescoring of structured data. The system 400 includes one or more processing devices 404 (only one shown) communicatively and operably coupled to one or more memory devices 406 (only one shown). The system 400 also includes a data storage system 408 that is communicatively and operably coupled to the processing device 404 and memory device 406 through a communications bus 402. In one or more embodiments, the communications bus 402, the processing device 404, the memory device 406, and the data storage system 408 are similar to their counterparts shown in FIG. 3, i.e., the communications bus 102, the processing device 104, the system memory 106, and the persistent storage devices 108, respectively. The system 400 further includes one or more input devices 410 and one or more output devices 412 communicatively and operably coupled to the communications bus 402.

In one or more embodiments, a behavior classification and prediction engine 420 is resident within the memory device 406. The behavior classification and prediction engine 420 (hereon referred to as the engine 420) includes an image generation module 422, one or more machine learning (ML) models 424 (only one shown), and a reshaping sub-module 426 to enable reshaping of images as described further herein. In some embodiments, the reshaping sub-module 426 is embedded within the image generation module 422. In some embodiments, the reshaping sub-module 426 is a separate module within the engine 420. In at least some embodiments, the engine 420 is a cognitive system. The image generation module 422 and the ML model 424 are discussed further herein. Also, in at least some embodiments, the data storage system 408 stores data including, without limitation, financial transaction/event data 430, original unlabeled transaction timeline images 440, labeled transaction timeline images 442, and reshaped transaction timeline images 444. In one or more embodiments, a plurality of transaction histories 432 associated with each respective target focal objects may be maintained within the financial transaction and event storage data 430.

In embodiments, the system 400 is communicatively and operably coupled to one or more financial institutions 450 (two shown), and in some embodiments, governmental institutions, through connections 452 via the communications bus 402, and in some embodiments, through the communications unit 110 (shown in FIG. 3). The financial institutions 450 transmit structured financial transaction and event data records 454 to the system 400 across the connections 452. In some embodiments, unstructured data may be used to supplement the structured data. The system 400 further includes one or more expert computing devices 460 though connections 462 via the communications bus 402, and in some embodiments, through the communications unit 110 (shown in FIG. 3). The expert computing devices 460 facilitate a subject matter expert (SME) receiving the original unlabeled transaction timeline images 440 for review by the SME. The SME may analyze the original unlabeled transaction timeline images 440 and assign one or more labels based on the structured financial transaction and event data records 454 to generate the labeled transaction timeline images 442. The expert computing devices 460 may include one or more of, and without limitation, a workstation, a personal computing device, a laptop computer, a desktop computer, a thin-client terminal, a tablet computer, a smart telephone, a smart watch, or other smart wearable devices, or other electronic devices that enable operation of the system 400 as described herein. In some embodiments, the system 400 is located within one or more of the financial institutions 450.

In various embodiments, the data storage system 408 may be distributed over multiple data storage devices included in the system 400 and the financial institutions 450, over multiple data storage devices (not shown) external to the system 400 and the financial institutions 450, or a combination thereof. In other embodiments, the data storage system 408 may be remote, such as on another server available via the communication bus 402.

According to at least one embodiment, the financial institutions 450 and the structured financial transaction and event data records 454 may be associated with one or more target focal objects that include, without limitation, the financial institutions 450 themselves, accounts registered with the financial institutions 450, and customers of the financial institutions 450. Customers may include, without limitation, organizations and business entities of any type and individuals. Transactions may include, without limitation, transactions between the customers and the financial institution 450 and/or internal transactions of the financial institution 450 associated with the customer. Events may include, without limitation, opening and closing of accounts, historical audits, and previous application of sanctions by authorities due to alleged criminal activities. The nature of the transactions and events associated with the financial transaction and event data 430 may vary considerably depending on the specific embodiments. In one or more embodiments, where the financial institution 450 is a bank, the financial transaction and event data 430 may be associated with a customer's checking or savings accounts. In one or more embodiments, where the financial institution 450 is an insurance company bank, the financial transaction and event data 430 may be associated with a customer's insurance policies. In embodiments, the nature of the financial institutions 450, transaction, events, and the respective financial transaction and event data records 454 enables operation of the system 400 as described herein. The financial transaction and event data records 454 are received by the system 400 and may be stored as the financial transaction and event data 430 resident within the data storage system 408.

In at least some embodiments, the financial transaction and event data records 454 may be processed to generate one or more respective transaction histories 432 (e.g., transactions over a period of time) within the financial transaction and event data 430 for a given target focal object's interactions with one or more of the financial institutions 450. In some embodiments, data from multiple financial institutions 450 transacting with the given target focal object may be aggregated to generate the respective transaction history 432. The relevant period of time indicated by the transaction history 432 may vary considerably (e.g., days, months, quarters, and years) according to one or more of system designer preferences, SME input, or time frames associated with particular transaction types or the preferences of the financial institutions 450. In the illustrative embodiments, each transaction and event may include information, such as, for example, a transaction amount, a transaction/event date, and a transaction/event type.

Cognitive systems, such as, the behavior classification and prediction engine 420, may be implemented to detect patterns in various data which human detection may fail to recognize. Some disclosed embodiments leverage this ability by representing the transaction histories 432 to exploit computer vision capabilities of such cognitive systems. Computer vision is a field of artificial intelligence (AI) directed to training machine learning (ML) models, such as ML models 424, to interpret and understand the visual world. In addition, in some embodiments, deep learning may be used where deep learning is a subset of machine learning where the neural networks learn from large amounts of data. The deep learning algorithms perform a task repeatedly and gradually improve the outcome through deep layers that enable progressive learning. Where conventional methods for transaction analysis, such as fraud detection, may rely on numerical and textual approaches (e.g., analyzing structured data), the disclosed embodiments instead utilize a graphical approach where the transaction history 432 is transformed into an original unlabeled transaction timeline image 440 by the image generation module 422 embedded within the engine 420.

In one embodiment, this process may include the image generation module 422 creating a graphic image, i.e., an original unlabeled transaction timeline image 440, e.g., and without limitation, a chart, a graph, a pictorial diagram, and each preferably with colors, representing a timeline for the respective transaction history 432 based on receiving the respective financial transaction and event data records 454. In some embodiments, the engine 420 may receive the original unlabeled transaction timeline image 440 and analyze the transaction history 432 represented by the original unlabeled transaction timeline image 440 to determine a behavior pattern classification for the transactions.

According to at least one embodiment, the engine 420, through cooperation of the image generation module 422 and the ML models 424, may assign a label to the respective original unlabeled transaction timeline image 440, thereby classifying the behavioral pattern detected based on previous training with historical/training transaction timeline images. In at least some of such embodiments, the engine 420 will generate at least a portion of the labeled transaction timeline images 442.

As brief discussed above, in at least some embodiments, the pattern recognition capabilities of the engine 420 may be implemented by training one or more of the ML models 424 using supervised learning techniques. In supervised learning, the ML models 424 may be trained using labeled data. In the present disclosure, the labeled data may original unlabeled transaction timeline image 440 annotated with behavioral pattern labels to generate the labeled transaction timeline images 442, such patterns indicative of, e.g., and without limitation, fraudulent behavior, small business entity behavior, and student behavior. The type of entity of the target focal objects may be added as external data. Labeled training data may typically be generated by the SME in the associated domain. For example, in embodiments where the original unlabeled transaction timeline image 440 may represent training data, the image generation module 422 may transmit the original unlabeled transaction timeline image 440 to the expert computing device 460 for review by the SME. The SME may analyze original unlabeled transaction timeline image 440 and assign one or more labels based on the respective transaction history 432. The labeled transaction timeline image 442 may then be fed into the engine 420 to train and test one or more of ML models 424 using supervised learning techniques.

If the engine 420 returns a label which indicates potentially criminal activities by the target focal object, e.g., potentially fraudulent behavior, appropriate action may be taken, such as generating a suspicious activity report for review by a system supervisor. In one embodiment, the supervisor may determine whether to escalate the matter and/or transmit the information to the particular financial institution 450 involved. In some implementations, responsive actions may be taken automatically by the engine 420 based on the alert, e.g., a suspicious activity report.

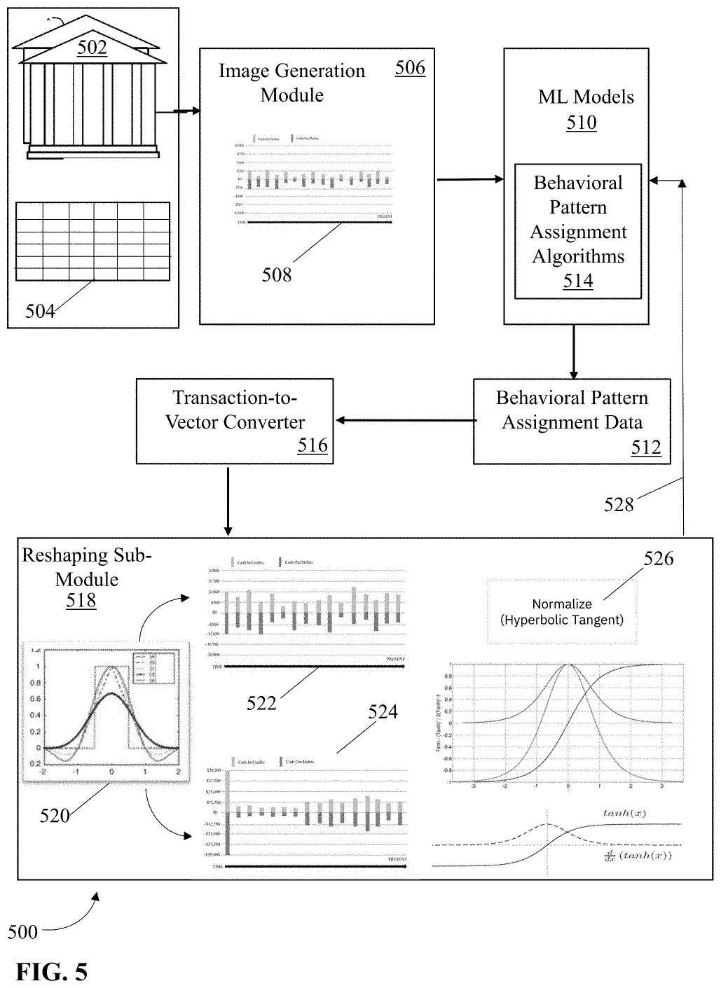

In one or more embodiments, the engine 420 is further configured to generate reshaped transaction timeline images 444 as described with respect to FIGS. 5 through 9.

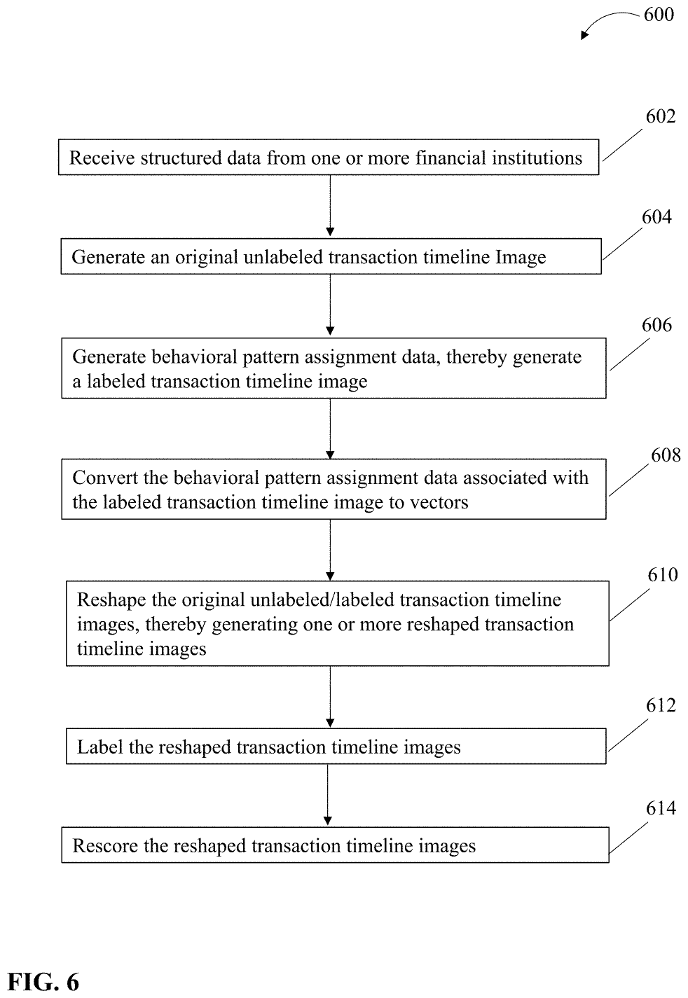

Referring to FIG. 5, a block diagram is provided illustrating a process 500 for determining risk (e.g., business risks in this example) through behavior classifications and predictions generated through timeline reshaping and rescoring of structured data. Also, referring to FIG. 6, a flowchart is provided illustrating a process 600 for determining risks, such as business risks, through behavior classifications and predictions generated through timeline reshaping and rescoring of structured data. In addition, referring to FIG. 4, a financial institution 502 (substantially similar to the financial institutions 450) includes a plurality of transaction histories 432 in the form of structured financial transaction and event data records 504 (substantially similar to the structured financial transaction and event data records 454), herein referred to as transaction records 504. The transaction records 504 include a plurality of sequential financial transactions and events. In one embodiment, the transaction records 504 are formatted as a flat database, i.e., a spreadsheet as shown in FIG. 5. In some embodiments, the transaction records 504 are formatted as a comma-separated values file. In some embodiments, the transaction records 504 are formatted in the respective native applications. Regardless of the format, the transaction records 504 are received 602 from one or more financial institutions 502 by the image generation module 506 (that is substantially similar to the image generation module 422) within the engine 420. In some embodiments, unstructured data may be used to supplement the structured data in the transaction records 504. More specifically, the image generation module 506 may have access to external data sources in addition to the financial institutions 502 which may provide information that may be salient to determining customer behavioral patterns.

In at least one embodiment, the image generation module 506 generates 604 one or more original unlabeled transaction timeline images 508 that are substantially similar to the original unlabeled transaction timeline images 440. In the embodiments described further herein, the transaction timeline images are colored bar graphs. In other embodiments, the images have any configuration that enables the system 400 and the engine 420 as described herein, including, and without limitation, a colorized graph and a colorized pictorial diagram.

As thus far described, the operations 602 and 604 are representative of those embodiments where newly ingested data to generate the original unlabeled transaction time line image 508. In some embodiments, the historical transaction histories 432 and historical labeled transaction images 442 may be revisited to implement the methods described herein with respect to reshaping the original unlabeled transaction time line images 508 and labeled transaction images 442.

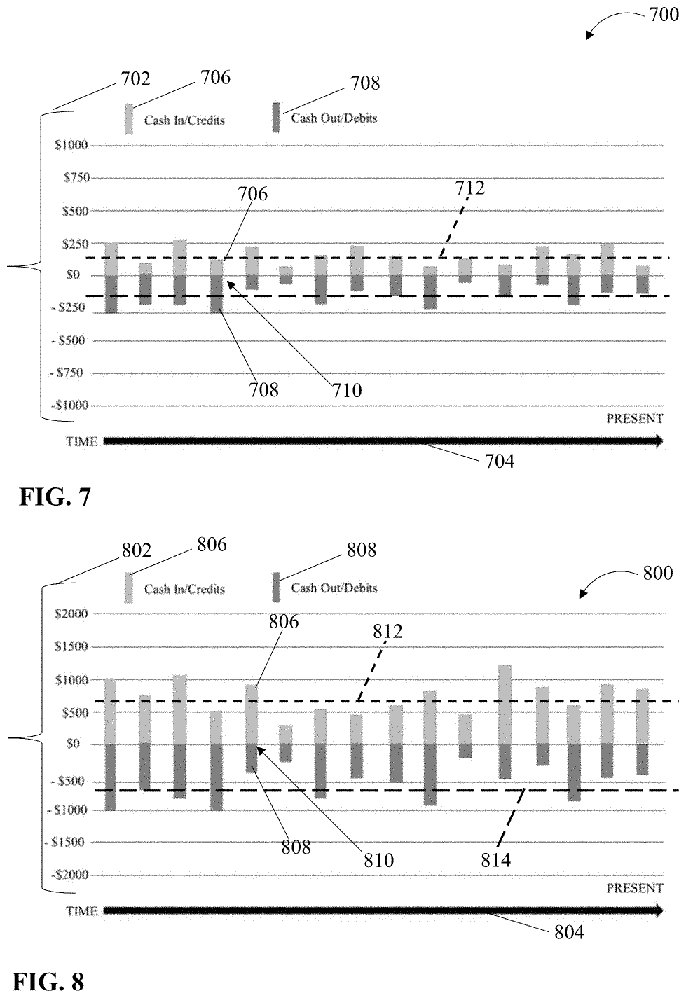

Referring to FIG. 7, a graphical diagram is presented illustrating an original unlabeled transaction timeline image 700, i.e., the image 700. Also, referring to FIGS. 4, 5, and 6, the image 700 represents a timeline for the respective transaction history 432 based on receiving 602 the respective financial transaction and event data records 454 (labeled 504 in FIG. 5). In at least some embodiments, the transaction information in the respective transaction history 432 has been accumulated over a sufficiently long period of time to enable a substantive transaction history 432, i.e., at least a predetermined number of weeks, and in some embodiments, possibly a predetermined number of months or a year. The 400 system then builds the transaction timeline image 700 from the financial transaction and event data records 504.

In some embodiments, the original unlabeled transaction timeline image 700 is a bar chart with numerical values 702 (in US dollars) on the left hand side and a time arrow 704 indicative of the oldest transaction data in the image 700 on the left hand side and the most recent transaction data, i.e., the present data, on the right hand side. The time scale in the image 700 is daily for 16 days, where the integer 16 is non-limiting. In one embodiment, the monetary scale extending from −$1000 to $1000 is indicative of the image 700 being reflective of a small business. In some embodiments, the monetary scale is in thousands or tens of thousands of US dollars thereby indicative of an intermediate-sized business. In some embodiments, the monetary scale is in hundreds of thousands or millions of US dollars, thereby indicative of a large business. The monetary scaling is typically established by the financial institution 502 (shown in FIG. 5); however, in some embodiments, the monetary scaling may be set by the user of system 400 (if different from the financial institution 502). Accordingly, the monetary scales of the image 700 have any scaling that enables operation of the system 400 and the engine 420 as described herein.

The lightly shaded bars are representative of cash inflows or credits, hereinafter referred to as credits 706. The heavier shaded bars are representative of cash outflows or debits, hereinafter referred to as debits 708. The color scheme used herein is selected to facilitate black and white presentations in the figures, and in typical embodiments, the color scheme is any scheme, typically selected by the financial institution 502, to clearly distinguish between predetermined classifications of transactions and events, including, without limitation, distinctions between structured and unstructured data. In some embodiments, the user of system 400 may have the ability to alter the color scheme. Accordingly, the color schemes of the image 700 are any schemes that enable operation of the system 400 and the engine 420 as described herein.

In some embodiments, cash flows, debits, and credits are shown separately; however, they are shown combined in image 700 for simplifying the description. Unless otherwise indicated herein, the actual values of the transactions are not relevant. Also, as shown in FIG. 7, the actual physical daily transactions are summarized into single daily transaction bars 710 (only one labeled in FIG. 7), each transaction bar 710 including both the credits 706 and debits 708. In some embodiments, the credits 706 and debits 708 are positioned separately, e.g., and without limitation, directly adjacent to each respective transaction.

The temporal scaling is typically established by the financial institution 502; however, in some embodiments, the temporal scaling may be set by the user of system 400 (if different from the financial institution 502). As discussed further herein, manipulation of the temporal scaling provides advantages in discovering unusual and/or potentially fraudulent activities. In some embodiments, the transaction timeline 704 is normalized according to the particular parameters set for this system 400. In general, normalization of the timeline 704 facilitates configuring the timeline 704 to a common time scale, where each increment of the timeline 704 may be considered a “bucket.” If the current timeline 704 is unusually short, then blank spaces may be added to fill in the relevant time period, or bucket. In addition, if the current timeline 704 is longer than necessary, it may be cropped. In addition, the image 700 may be supplemented with metadata as desired to distinguish between the classes of transactions and events, and to provide information such as, and without limitation, the size of the target focal object being analyzed. FIG. 7 also shows an average credits line 712 at approximately $150 per day and an average debits line 714 at approximately $142 per day. A discussion of the notable features of the image 700, including comparisons with subsequent reshaped images is provided further herein. However, suffice it to say, for now, that the image 700 shows no unusual features that may be identified by the system 400. Accordingly, the temporal scales of the image 700 have any scaling that enables operation of the system 400 and the engine 420 as described herein.

Referring again to FIGS. 4, 5, and 6, in one or more embodiments, the process 600 includes generating 606 behavioral pattern assignment data 512 through the one or more ML models 510 (that are substantially similar to the ML models 424.) The generating operation 606 includes ingesting the respective financial transaction and event data records 504 and the one or more original unlabeled transaction timeline images 508 and analyzing the ingested data through labeling the original unlabeled transaction timeline images 508. In at least one embodiments, one or more behavioral pattern assignment applications, or algorithms 514 embedded within the ML models 510, may leverage the historical supervised machine learning to label the original unlabeled transaction timeline images 508 representing the transaction histories associated with target focal objects as previously described herein. The labeling is executed through comparing the present original unlabeled transaction timeline images 508 with the respective labeled historical timeline images, where the labeling is substantially representative of the known behavior patterns through which the ML models 510 were trained. Also, in some embodiments, the aforementioned algorithms 514 may produce a score or confidence value indicating the likelihood that a particular answer, i.e., behavioral pattern label, is correct. In some embodiments, the behavioral pattern labels assigned as behavioral pattern assignment data 512 includes, without limitation, non-fraudulent, fraudulent, small business, individual, etc., through matching the current original transaction timeline image 508 to the behavioral patterns learned from the historical transaction timeline images (e.g., known behavioral patterns) and assign the corresponding label to the current transaction timeline image. In some embodiments, the assigned labels may be restricted to a list of known behavioral patterns, or if a particular patterns is not recognized, a new label may be applied through interaction with the SME. Accordingly, the original transaction timeline image 508 is labeled and a score or confidence value is assigned to the respective predictions, thereby creating one or more labeled transaction images 442 based on the respective original transaction timeline images 508 and the respective transaction histories 432.

In at least one embodiment, in preparation for further processing by the engine 420 within the system 400, the transaction data associated with the respective transaction histories 432, the respective behavioral pattern assignment data 512, and the respective labeled transaction timeline image 442 is converted 608 to vectors by a transaction-to-event converter 516. The converted data is transmitted to the reshaping sub-module 518 (shown as 426 in FIG. 4). In FIG. 5, the reshaping sub-module 518 is shown disassociated from the image generation module 506 in contrast to FIG. 4 for purposes of clarity. The reshaping module 518 is configured to reshape 610 one or more of the original unlabeled timeline images 508 and the labeled transaction timeline images 442 through altering the profile of the images 508 and 442 through manipulating the respective time scale. Specifically, the transaction histories 432 are revisited to reshape the profiles of the original unlabeled timeline images 508 and the labeled transaction timeline images 442.

In at least some embodiments, the reshaping operation 610 includes executing a reshaping operation 520. In some embodiments, the reshaping operation 520 includes a first normalization through one or more normalization techniques, including, without limitation, minimum/maximum scaling and z-score normalization. The first normalization facilitates preparing the data for consistency for the subsequent manual reshaping such that the reshaping operation 520 may generate consistent results. In some embodiments, the reshaping operation 520 is executed on the labeled transaction images 442 with a first temporal range manually by an SME, where the SME utilizes user interface timeline compression or elongation at the expert computing device 460 to test if any patterns discovered within a second temporal range are similar to other existing patterns by forcing a rescoring (discussed further). In some embodiments, the reshaping operation 520 is executed automatically through predetermined operations by the reshaping sub-module 518. Once the normalization parameters are established, and the reshaping operation 520 is executed, the new reshaped transaction timeline images 522 and 524 (shown as 444 in FIG. 4) are generated, where 2 is a non-limiting value.

Referring to FIG. 8, a graphical diagram is presented illustrating a reshaped unlabeled transaction timeline image 800, i.e., the reshaped image 800. In a manner similar to FIG. 7, the reshaped image 800 is a bar chart with numerical values 802 (in US dollars) on the left hand side and a time arrow 804 indicative of the oldest transaction data in the reshaped image 800 on the left hand side and the most recent transaction data, i.e., the present data, on the right hand side. The time scale in the reshaped image 800 is weekly for 16 weeks, where the integer 16 is non-limiting. In one embodiment, the monetary scale extending from −$2000 to $2000 is indicative of the reshaped image 800 being reflective of the same target focal point of FIG. 7, i.e., a small business. The lightly shaded bars are representative of cash inflows or credits, hereinafter referred to as credits 806. The heavier shaded bars are representative of cash outflows or debits, hereinafter referred to as debits 808. Also, as shown in FIG. 8, the actual physical weekly transactions are summarized into single weekly transaction bars 810 (only one labeled in FIG. 8), each transaction bar 810 including both the credits 806 and debits 808. In addition, FIG. 8 also shows an average credits line 812 at approximately $900 per week and an average debits line 814 at approximately $560 per week. The values associated with lines 812 and 814 are fairly consistent with the lines 712 and 714, respectively. In some embodiments, the low margins may be suspect, i.e., approximately $8 per day and approximately $48 per week. However, in general the daily features in FIG. 7 and the weekly features in FIG. 8 are not likely to be found as unusual by the system 400.

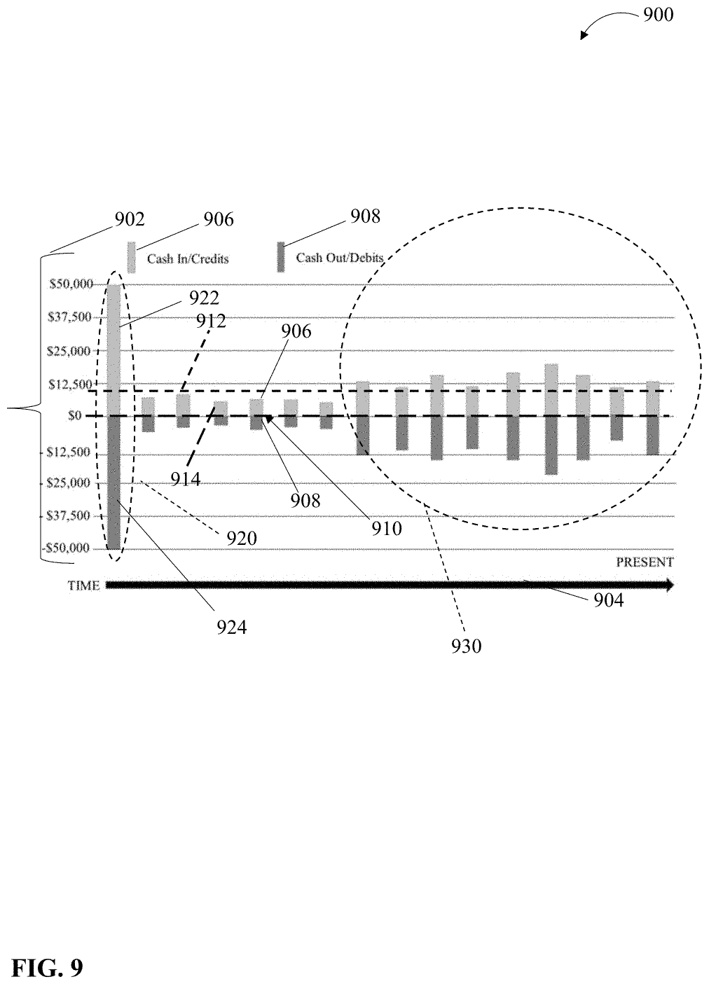

Referring to FIG. 9, a graphical diagram is presented illustrating a reshaped unlabeled transaction timeline image 900, i.e., the reshaped image 900. In a manner similar to FIGS. 7 and 8, the reshaped image 900 is a bar chart with numerical values 902 (in US dollars) on the left hand side and a time arrow 904 indicative of the oldest transaction data in the reshaped image 900 on the left hand side and the most recent transaction data, i.e., the present data, on the right hand side. The time scale in the reshaped image 900 is monthly for 16 months, where the integer 16 is non-limiting. In one embodiment, the monetary scale extending from −$50,000 to $50,000 is indicative of the reshaped image 900 being reflective of the same target focal point of FIGS. 7 and 8, i.e., a small business, but with an unexpectedly extended financial scale on the left side. The lightly shaded bars are representative of cash inflows or credits, hereinafter referred to as credits 906. The heavier shaded bars are representative of cash outflows or debits, hereinafter referred to as debits 908. Also, as shown in FIG. 9, the actual physical monthly transactions are summarized into single monthly transaction bars 910 (only one labeled in FIG. 8), each transaction bar 910 including both the credits 906 and debits 908.

In addition, FIG. 9 also shows the average credits line 912 of approximately $3600 per month (four times the value associated with 812 of FIG. 8) and an average debits line 914 of approximately $3400 per month (four times the value associated with 814 of FIG. 8). In general, many of the values associated with FIG. 9 are fairly consistent with the values found in FIG. 8. However, FIG. 9 also indicates two anomalies 920 and 930, shown within dashed enclosures. The first anomaly 920 indicates a monthly credit aggregate 922 of approximately $50,000 and a monthly debit aggregate 924 of approximately $50,000. Such large deposits and withdrawals of cash well beyond historical norms can be indicative of fraudulent activity, such as, and without limitation, potential money laundering. Notably, such large amounts might be evident in the daily or weekly images 700 and 800, respectively, however a review of multiple versions of those images 700 and 800 may be necessary. The second anomaly 930 indicates a notable monthly increase of credits and debits over a period of time. The step increase that is substantially consistent over the previous 9 months would trigger the system 400 to at least identify the monthly sequence as at least suspicious, unless a SME added some meta data indicating a legitimate expansion of the business. A review of the data associated with the anomaly 930 in a weekly or daily image such as images 700 and 800 may go unnoticed. In addition, gradual increases over time rather than step changes as shown may best be discovered in quarterly images (not shown) combined with the monthly image 900. Moreover, anomalous aggregated transactions with a certain periodicity would be more discernible in those images with the timelines that cover a larger temporal period. Furthermore, a weekly or daily image that shows the period just before and after initiation of the anomaly 939 may also show an unusual or unexpected change in behavior. Accordingly, aggregation and de-aggregation of transactions may be used to leverage image reshaping as described herein to identify or predict potential fraudulent behaviors and behavior patterns.

In at least some embodiments, the image reshaping operation 610 includes normalizing the different scales of the reshaped images 800 and 900 such that the respective timelines are normalized with one or more different scales which alters the illustrated features of the frequencies of transactions and the aggregations of the transactions. In some embodiments, normalization techniques such as, and without limitation, hyperbolic tangent (Tanh) normalization 526 is used, to perform the second normalization to facilitate consistency of the reshaped images 800 and 900 to further facilitate recognition by the ML models 424. However, any normalization techniques to form buckets of any size along the respective timelines may be used. The resulting reshaping may illustrate patterns of behavior previously not evident when the reshaped images are compared to each other. In some embodiments, the reshaping may be executed automatically based on predetermined timeline scaling. In some embodiments, the reshaping may be executed through interface with the SME. In some embodiments, the SME may mark-up the images prior to reingestion by the ML model.

In one or more embodiments, the reshaped, normalized transaction timeline images 528 are transmitted to the behavioral pattern assignment algorithms 514 for analysis and labeling 612. The new labeling 612 facilitates rescoring 614 the images 528, thereby facilitating determinations of the associated risks with the target focal object, including behavior classifications and predictions through the timeline reshaping and the rescoring of the structured data. In some embodiments, the reshaping process as described herein may be iterative, i.e., additional reshaped images may be generated based on the analysis of the previous iteration.

The system, computer program product, and method as disclosed herein facilitates overcoming the disadvantages and limitations of known mechanisms for analyzing structured data and predicting fraudulent behavior patterns therefrom to determine potential risks, e.g., and without limitation, business risks. Although examples discussed above involve business risks, it is to be understood that the techniques described here can be applied to other non-business and/or non-financial risks. As disclosed herein, historical data and historical transaction timeline images are reshaped and rescored to identify potentially fraudulent activities that would otherwise remain undiscovered due to the formatting of the data within the historical transaction timeline images. The reshaped transaction timeline images include one or more of, for example, and without limitation, compressed or elongated time lines such that the appearance of the reshaped transaction timeline images are different from the historical transaction timeline images. The newly created transaction timeline images are then retested, i.e., reanalyzed to determine if there are any patterns that may be similar to the known patterns representative of potentially fraudulent activities through a forced rescoring thereof. Furthermore, the reshaped transaction timeline images may be labeled to indicate newly identified fraudulent activities and are input into the respective ML models to train the ML models to identify potentially fraudulent activities on subsequent data inputs for the target focal objects.

In addition, the systems and methods described herein may be used on newly ingested data to generate the varying transaction timeline images to generate the multiple transaction timeline images to analyze the new data with the additional mechanisms described herein. Therefore, the present disclosure provides improvements to known supervised learning mechanisms through a deep learning process. Moreover, the methods and systems described herein facilitate transactions histories of variable sizes and variable temporal features of the transactions and events, regardless of their nature, including, without limitation, different time scales, frequencies, and granularities. Therefore, those target focal objects with highly variable numbers of historical transactions to be standardized and used to predict behavior may be processed to identify variabilities introduced to fool systems reliant on consistent time spans between transactions and events. Accordingly, significant improvements to known known mechanisms for analyzing structured data and predicting fraudulent behavior patterns therefrom to determine potential business risks are realized through the present disclosure.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer system comprising:
one or more processing devices and at least one memory device operably coupled to the one or more processing devices, the one or more processing devices are configured to:
receive, for one or more target focal objects, at least a portion of a transaction history including a plurality of sequential transactions, wherein the portion of the transaction history is associated with a first temporal range;
generate a first transaction timeline image representative of the portion of the transaction history, wherein the first temporal range includes a first temporal scaling;
label, through a machine learning (ML) model, the first transaction timeline image;
reshape the first transaction timeline image, comprising:
rescale the first temporal range; and
generate a rescaled transaction timeline image; and
label the rescaled transaction timeline image.

2. The system of claim 1, wherein the one or more processing devices are further configured to:
train the ML model with one or more historical transaction timeline images, each historical transaction timeline image of the one or more historical transaction timeline images including one or more labels at least partially representative of one or more known behavior patterns.

3. The system of claim 1, wherein the one or more processing devices are further configured to:
label the first transaction timeline image, thereby to generate a first labeled transaction timeline image; and
reshape the first transaction timeline image, thereby to alter a profile of the first labeled transaction timeline image through manipulation of a respective time scale.

4. The system of claim 3, wherein the one or more processing devices are further configured to:
compare the rescaled transaction timeline image with at least a portion of the one or more historical timeline images; and
determine at least a partial match of the one or more known behavior patterns between the rescaled transaction timeline image and the at least a portion of the one or more of historical transaction timeline images.

5. The system of claim 1, wherein the one or more processing devices are further configured to:
normalize the first transaction timeline image through one or more of timeline compression and timeline elongation, thereby establishing a second temporal range.

6. The system of claim 5, wherein the one or more processing devices are further configured to:
execute one of aggregation and de-aggregation of one or more transactions in the first labeled transaction timeline image, thereby identifying one or more potentially fraudulent behavior patterns.

7. The system of claim 6, wherein the one or more processing devices are further configured to:
rescore the reshaped transaction timeline image, including generation of a confidence value associated with each of the respective one or more identified potentially fraudulent behavior patterns.

8. A computer program product, the computer program product comprising:
one or more computer readable storage media; and
program instructions collectively stored on the one or more computer-readable storage media, the program instructions comprising:
program instructions to receive, for one or more target focal objects, at least a portion of a transaction history including a plurality of sequential transactions, wherein the portion of the transaction history is associated with a first temporal range;
program instructions to generate a first transaction timeline image representative of the portion of the transaction history, wherein the first temporal range includes a first temporal scaling;
program instructions to label, through a machine learning (ML) model, the first transaction timeline image;
program instructions to reshape the first transaction timeline image, comprising:
program instructions to rescale the first temporal range; and
program instructions to generate a rescaled transaction timeline image; and
program instructions to label the rescaled transaction timeline image.

9. The computer program product of claim 8, further comprising:
program instructions to train the ML model with one or more historical transaction timeline images, each historical transaction timeline image of the one or more of historical transaction timeline images including one or more labels at least partially representative of one or more known behavior patterns.

10. The computer program product of claim 9, further comprising:
program instructions to label the first transaction timeline image and generate a first labeled transaction timeline image; and
program instructions to reshape the first transaction timeline image and alter a profile of the first labeled transaction timeline image through manipulation of a respective time scale.

11. The computer program product of claim 10, further comprising:
program instructions to compare the rescaled transaction timeline image with at least a portion of the one or more historical timeline images; and
program instructions to determine at least a partial match of the one or more known behavior patterns between the rescaled transaction timeline image and the at least a portion of the one or more of historical transaction timeline images.

12. The computer program product of claim 8, further comprising:
program instructions to normalize the first transaction timeline image through one or more of timeline compression and timeline elongation, thereby establishing a second temporal range.

13. The computer program product of claim 12, further comprising:
program instructions to execute one of aggregation and de-aggregation of one or more transactions in the first labeled transaction timeline image and identify one or more potentially fraudulent behavior patterns; and
program instructions to rescore the reshaped transaction timeline image through generation of a confidence value associated with each of the respective one or more identified potential fraudulent behavior patterns.

14. A computer-implemented method comprising:
receiving, for one or more target focal objects, at least a portion of a transaction history including a plurality of sequential transactions, wherein the portion of the transaction history is associated with a first temporal range;
generating a first transaction timeline image representative of the portion of the transaction history, wherein the first temporal range includes a first temporal scaling;
labeling, through a machine learning (ML) model, the first transaction timeline image;
reshaping the first transaction timeline image, comprising:
rescaling the first temporal range; and
generating a resealed transaction timeline image; and
labeling the resealed transaction timeline image.

15. The method of claim 14, further comprising:
training the ML model with one or more historical transaction timeline images, each historical transaction timeline image of the one or more of historical transaction timeline images including one or more labels at least partially representative of one or more known behavior patterns.

16. The method of claim 14, wherein:
labeling the first transaction timeline image comprises generating a first labeled transaction timeline image; and
reshaping the first transaction timeline image comprises altering a profile of the first labeled transaction timeline image through manipulating a respective time scale.

17. The method of claim 16, wherein labeling the resealed transaction timeline image comprises:
comparing the resealed transaction timeline image with at least a portion of the one or more historical timeline images; and
determining at least a partial match of the one or more known behavior patterns between the resealed transaction timeline image and the at least a portion of the one or more of historical transaction timeline images.

18. The method of claim 14, wherein rescaling the first temporal range comprises:
normalizing the first transaction timeline image through one or more of timeline compression and timeline elongation, thereby establishing a second temporal range.

19. The method of claim 18, wherein reshaping the first transaction timeline image further comprises:
one of aggregation and de-aggregation of one or more transactions in the first labeled transaction timeline image, thereby identifying one or more potentially fraudulent behavior patterns.

20. The method of claim 19, further comprising:
rescoring the reshaped transaction timeline image, wherein the rescoring comprises generating a confidence value associated with each of the respective one or more identified potential fraudulent behavior patterns.
